(19) United States
(12) Patent Application Publication
(10) Pub. No.: US 2026/0298186 A1
(43) Pub. Date: Oct. 1, 2026

(54) FUEL INJECTOR WITH CONFIGURABLE CONTROL VALVE OUTLET

(71) Applicant: Stanadyne Operating Company LLC, Jacksonville, NC (US)

(72) Inventors: Srinu Gunturu, Lexington, SC (US); Clark A. Klyza, Blythewood, SC (US)

(21) Appl. No.: 19/095,769

(22) Filed: Mar. 31, 2025

(51) Int. Cl. F02M 51/06

(52) U.S. Cl. CPC F02M 51/0625

(57) ABSTRACT

A control valve member and control valve seat are configured to produce a first pressure region adjacent the needle control chamber exit that maintains a first fuel pressure while the control valve is open, and a flow restriction between the control valve exit chamber and a region of low fuel pressure maintains a second pressure region at a second fuel pressure in the control valve exit chamber while the control valve is open. Both the first and second fuel pressures are higher than a vapor pressure of the fuel, with the first fuel pressure being greater than the second fuel pressure. The elevated fuel pressures at the control valve seat and in the control valve exit chamber prevent cavitation. The flow restriction from the control valve exit chamber may be defined by an insert received in a bore, allowing adjustment of the flow restriction by replacement of the insert.

### FIELD

This disclosure relates generally to fuel injection systems for internal combustion engines. In particular this disclosure relates to modular fuel injectors configured to allow adjustment of operational characteristics by exchange of inexpensive components.

### BACKGROUND

Fuel injected internal combustion engines include injectors coupled to a pressurized source of fuel for delivering the fuel into the engine cylinders. The injectors are controlled by a control system which actuates and causes the injectors to deliver the desired amounts of fuel at desired times. Each injection event by which a commanded quantity of fuel is delivered to an engine cylinder for ignition may be the result of a plurality of discrete or separate injection pulses over a period of time (i.e., the quantity of fuel provided during the injection event is the sum of the quantities of the injection pulses associated with the injection event). Increasing fuel efficiency standards and stringent emissions requirements are driving a need for fuel injectors that operate at very high pressures and are capable of delivering fast, precisely timed injection events, each of which delivers a defined quantity of atomized fuel to the combustion chamber.

To optimize diesel engine combustion, it is necessary to precisely control the timing and quantity of fuel delivered by each fuel injector to the combustion chamber for each combustion cycle. Typically, a diesel common rail (DCR) injector includes an injection nozzle having an injector needle which is movable away from a needle seat to allow pressurized fuel to flow through orifices downstream of the needle seat to deliver atomized fuel to the combustion chamber. Movement of the injector needle may be controlled hydraulically by means of a needle control valve, which controls fuel pressure in a needle control chamber. The needle control valve opens an orifice, relieving pressure in the needle control chamber, which allows the injector needle to move away from the needle seat. Precision control of each fuel injection event requires the control valve and injector needle to open and close quickly, without irregular or uncontrolled stutter or bounce.

Since the introduction of the Diesel Common Rail (DCR) fuel system, there have been many advancements in materials, design, and manufacturing that allow for operation at ever increasing fluid pressures, operation at or above 2000 bar is typical. One potentially detrimental result of higher fuel pressure is the increased likelihood of cavitation formation. Cavitation happens when the pressure within a liquid falls below the vapor pressure of the liquid. This can occur in areas of high fluid velocity, such as within fuel pumps or injectors. When the pressure drops sufficiently, the liquid fuel “boils” and forms vapor bubbles, even at relatively low temperatures. As these vapor bubbles move into areas of higher pressure, they implode or collapse violently. This collapse generates intense shock waves and micro-jets of liquid, which can erode and damage the surfaces of fuel system components.

Various regions of the injector are susceptible to cavitation erosion due to sudden changes in fluid pressure. One such region of concern is at and near the control valve outlet orifice. Design efforts have mitigated this issue to an extent, but many high hour injectors still exhibit cavitation erosion at and near the outlet orifice sealing region. Cavitation erosion at and near the control valve outlet orifice can progress over time and lead to leakage, shifts in injection control, abnormal emissions and ultimately failures in the field.

There is a need for fuel injectors configured to operate at very high fuel pressures without cavitation damage that can degrade injector reliability over the lifetime of the internal combustion engine.

### SUMMARY OF THE INVENTION

This disclosure describes a fuel injector control valve configured to mitigate and possibly eliminate cavitation formation at and near an outlet orifice of a control chamber during the release of high-pressure fuel. The control valve is a solenoid operated valve arranged to close or open an outlet of a needle control chamber filled with high-pressure fuel. When the control valve is closed, the needle control chamber is pressurized and generates a closing force on a control rod or injector needle to maintain the injector needle in a closed position. When the control valve is opened, high-pressure fuel is released from the needle control chamber, removing the closing force which allows the injector needle to open to initiate fuel injection through injection orifices at a nozzle end of the injector. According to aspects of the disclosure, a control valve exit chamber surrounds a control valve seat and a control valve exit chamber flow restriction between the control valve exit chamber and a low-pressure fuel return flow path maintains fuel pressure in the control valve exit chamber above a vapor pressure of the fuel.

According to further aspects of the disclosure, the control valve member and the control valve seat are configured to produce a first pressure region adjacent the needle control chamber exit that maintains a first fuel pressure while the control valve is open, and a flow restriction between the control valve exit chamber and a region of low fuel pressure maintains a second pressure region at a second fuel pressure in the control valve exit chamber while the control valve is open. Both the first and second fuel pressures are higher than a vapor pressure of the fuel, with the first fuel pressure being greater than the second fuel pressure. The elevated fuel pressures at the control valve seat and in the control valve exit chamber prevent cavitation.

According to aspects of the disclosure, the control valve member has a planar control valve surface that cooperates with a recess surrounding the needle control chamber outlet to produce the first fuel pressure in the recess while the control valve is open. The volume of the control valve exit chamber and restricted outlet from the control valve exit chamber produce the second fuel pressure in the control valve exit chamber while the control valve is open.

The control valve seat is configured to cooperate with a planar control valve surface on the control valve member to manage the flow of high-pressure fuel released from the needle control chamber. The control valve seat includes a planar central region surrounding a needle control chamber outlet and a recess surrounding the planar central region. The control valve seat may include a second planar region radially separated from the central planar region by the recess, which may be referred to as an “outer region” of the control valve seat. The planar control valve surface spans the recess to contact the second planar region when the control valve member is in the closed position. The control valve seat may include one or more radial cuts connecting the recess to the control valve exit chamber. The one or more radial cuts allow high-pressure fuel in the recess to flow into the control valve exit chamber. In one embodiment, the control valve seat includes four radial cuts connecting the recess to the control valve exit chamber. In this embodiment, the four radial cuts are substantially identical and are arranged at equal angular positions around the recess. The recess may take the form of a half-torus, or circular groove with a semi-circular profile. The recess is not limited to this configuration. The planar control valve surface cooperates with the valve seat to generate a controlled drop in fuel pressure adjacent the outlet of the needle control chamber to limit or eliminate cavitation at the control valve set.

According to other aspects of the disclosure, embodiments of the disclosed fuel injector use threaded couplings to complete a pressure-tight enclosure, where the threaded couplings allow access to all interior components of the fuel injector. The disclosed fuel injectors are modular, with a cap assembly at an outer end of the injectors including the solenoid coil and pole, an electrical connector and conductors for the coil, and a low-pressure fuel return outlet for connection to a low-pressure fuel return flow path returning fuel to a fuel tank. A cap collar engages a threaded outer end coupling on the injector body to retain the cap assembly to the injector body. An annular spacer between the body of the cap assembly and the injector body determines the position of the cap assembly relative to the cap body. The position of the cap assembly defines an air gap between the solenoid pole and an armature when the coil is not energized. An armature spring seat on the armature is used to set the stroke of the armature and control valve member when the coil is energized to attract the armature toward the solenoid pole. A spring shim carried by the armature spring seat is used to set the spring force of the armature spring on the armature. According to aspects to the disclosure, reversal of the threaded connection between the injector body and the cap collar allows replacement of the annular spacer, armature spring seat and spring shim. This configuration allows the armature air gap, armature/control valve member stroke, and armature spring force to be adjusted by replacement of the annular spacer, armature spring seat, and spring shim, respectively.

The disclosed fuel injector employs a threaded nozzle collar to form a reversible connection between the nozzle end of the injector body and the injector nozzle. An injector needle in the injector nozzle is biased toward a closed position by a needle spring in a needle spring chamber cooperatively defined by the injector body and injector nozzle. An embodiment of the disclosed fuel injector employs a control rod extending from the needle control chamber to transmit an additional closing force generated by high-pressure fuel in the needle control chamber to the injector needle via a needle lift spacer. An alignment coupling surrounds the lower end of the control rod, upper end of the injector needle and needle lift shim. The needle spring is compressed between the alignment coupling and a needle spring shim and the alignment coupling delivers force of the needle spring to the upper end of the injector needle separately from the closing force of the control rod. A force of the needle spring is set by the combined axial height of the needle spring shim and the alignment coupling (between the upper end of the injector needle and the lower end of the needle spring). The disclosed injector configuration allows adjustment of the needle lift and needle spring force by separation of the threaded connection between the injector nozzle and the injector body and replacement of the needle lift spacer, needle spring shim and/or alignment coupling, respectively.

### BRIEF DESCRIPTION OF THE DRAWINGS

FIG. 1 is a longitudinal sectional view through an embodiment of a fuel injector according to aspects of the disclosure;

FIG. 2 is an enlarged longitudinal sectional view of the nozzle tip of the fuel injector of FIG. 1;

FIG. 3 is an enlarged sectional view of the control valve solenoid and armature of the fuel injector of FIG. 1;

FIG. 4 is an enlarged view of the upper portion of the fuel injector of FIG. 1, showing details of the needle control chamber, clamping screw and control valve solenoid;

FIG. 5 is an enlarged view of the needle control valve of the fuel injector of FIGS. 1-4 showing details of the control valve member, control valve seat, control valve exit chamber and flow restriction at the exit of the control valve exit chamber according to aspects of the disclosure;

FIG. 6 is an enlarged top view of the upper end face of the control module of the fuel injector of FIGS. 1-5, showing details of the control valve seat, portions of the control valve exit chamber defined on the upper end of the control module and areas of contact between the control valve member and the control valve seat;

FIG. 7 is an enlarged top view of the upper end face of the control module of FIG. 6, with the control valve member shown in functional conjunction with the control valve seat;

FIG. 8 is a graphical presentation of the relationship between cavitation at the control valve seat and the diameter of the flow restriction at the exit of the control valve exit chamber of the fuel injector of FIGS. 1-7;

FIG. 9 is a graphical presentation of the relationship between pressure in the control valve exit chamber and cavitation of the fuel injector of FIGS. 1-7;

FIG. 10 is a graphical presentation of the relationship between pressure in the control valve exit chamber to the diameter of a flow restriction between the control valve exit chamber and a low-pressure fuel return flow path;

FIG. 11 is a graphical presentation of simulations of pressure changes in the control valve exit chamber of the fuel injector of FIGS. 1-7 at pressures of 3600 bar and 250 bar, with and without a flow restriction between the control valve exit chamber and a low-pressure fuel return flow path;

FIG. 12 is a graphical presentation of simulated control valve member opening and closing velocity of the fuel injector of FIGS. 1-7 at 3600 bar and 250 bar with and without a flow restriction between the control valve exit chamber and a low-pressure fuel return flow path;

FIG. 13 is a graphical presentation of control valve (CV) member lift and injector needle lift in a disclosed embodiment of a fuel injector; and

FIG. 14 is a graphical presentation of fuel pressure at the recess surrounding the control valve outlet (c7), fuel pressure in the control valve exit chamber (c8) and in the low-pressure fuel return flow path after the control valve exit chamber flow restriction.

### DETAILED DESCRIPTION

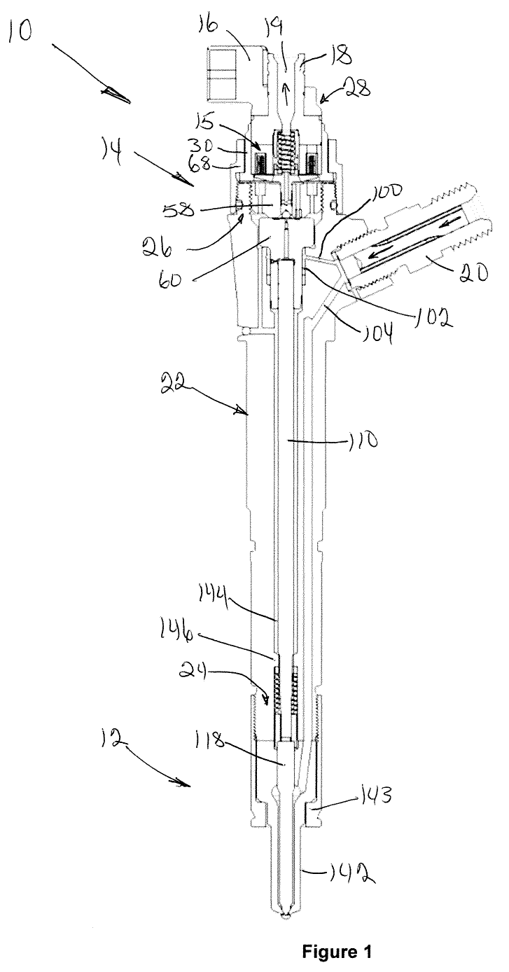

FIG. 1 is a longitudinal sectional view through an embodiment of a fuel injector 10 configured according to aspects of the disclosure. The fuel injector 10 is configured for use in a Deisel common rail (DCR) fuel system operating at fuel pressures up to 3600 bar. The fuel injector 10 has an elongated configuration extending from a nozzle end 12 positioned in the combustion chamber of an engine cylinder to an outer end 14 including an electrical connector 16, a low-pressure fuel return outlet 18, and a high-pressure fuel inlet 20. The low-pressure fuel outlet 18 connects the fuel injector to a low-pressure fuel return flow path 19 to the fuel tank and is at essentially zero pressure, which may also be referred to as “exit pressure.” The high-pressure fuel inlet 20 connects the fuel injector 10 to a source of high-pressure fuel, such as a diesel common rail (not shown) supplied with pressurized fuel by a high-pressure fuel pump (not shown). The electrical connector 16 supplies electrical current to a solenoid-driven control valve 15. Operation of the control valve 15 is directed by an engine control unit (ECU) or other controller (not shown) in a manner known in the art. An injector body 22 extends from a threaded nozzle end coupling 24 adjacent the nozzle end 12 of the fuel injector 10 to a threaded outer end coupling 26 adjacent the outer end 14 of the fuel injector 10. In the disclosed embodiment, the outer end coupling 26 and nozzle end coupling 24 are threaded couplings that can be separated to allow access to all the interior components of the fuel injector 10. A cap assembly 28 connects to the threaded outer end coupling 26 and closes the outer end 14 of the fuel injector 10. The cap assembly 28 includes an annular cap body 30 laser welded to the low-pressure fuel return outlet 18. A solenoid coil 32 and pole 34 are retained in the cap body 30 before the cap body 30 is welded to the fuel return outlet 18, with an outer circumference of the pole 34 supported on an inward projecting shoulder 36 of the cap body 30. A bore 38 extends axially through the solenoid pole 34 and into the fuel return outlet 18. An armature spring cage 40 is seated against a spring cage stop 42 defined at the upper end of the bore 38, which determines a position of the armature spring cage 40 along an axis of the solenoid. The armature spring cage 40 includes a cross bore allowing low-pressure fuel to pass radially through the sides of the armature spring cage 40, along an axis of the armature spring 44 and out of the low-pressure fuel return outlet 18. The armature spring 44 is compressed between an upper end of the armature cage 40 and an armature spring seat 46 on an upper end of an armature 48.

In the disclosed embodiment, the armature 48 includes a radially projecting flange 50 facing the solenoid pole 34 and coil 32 and an integral axially extending valve stem 52. The flange 50 is tapered at its outer periphery to reduce the mass of the armature 48. A control valve member 54 is affixed to an end of the valve stem 52 opposite the flange 50. The valve stem 52 extends into an axial bore 56 of a clamping screw 58, which engages the threaded outer end coupling 26 to retain a control module 60 within the injector body 22. The valve stem 52 is closely received in the axial bore 56 of the clamping screw 58, which guides reciprocal movement of the valve stem 52 and control valve member 54. The valve stem 52 includes an axial bore 62, transverse bore 64, and annular recess 66 surrounding the valve stem 52 to allow fuel to lubricate the interface of the valve stem 52 and axial bore 56 in the clamping screw 58.

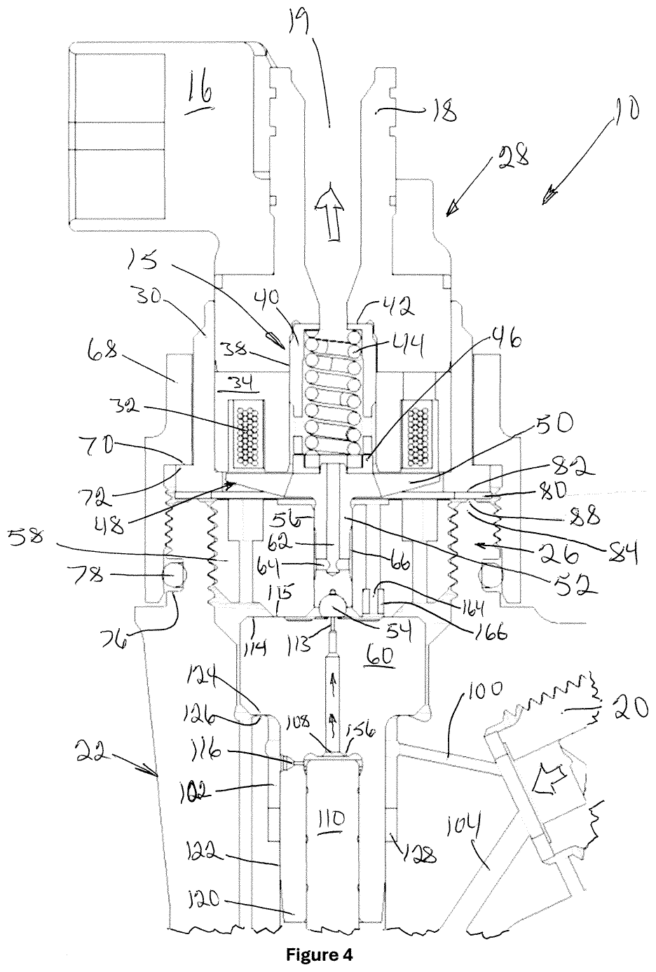

In the disclosed embodiment of a fuel injector 10, the injector body 22 includes a threaded outer end coupling 26 which includes an outward facing male thread and inward facing female thread. The clamping screw 58 includes a male thread engaged with the female thread of the outer end coupling 26, allowing the clamping screw 58 to be tightened against the control module 60. When tightened, the clamping screw 58 and control module 60 are retained in fixed positions within the injector body 22. An annular cap collar 68 includes an inward-projecting shoulder 70 that radially overlaps with an outward-projecting shoulder 72 on the cap body 30 and includes a skirt 74 with an inward facing female thread engaged with the outward facing male thread at the outer end coupling 26 of the injector body 22. The outer end coupling 26 of the injector body 22 defines an annular seal gland 76 that retains a seal 78 to contain fuel within the injector body 22. The cap collar 68 retains the cap assembly 28 to the injector body 22. The cap collar 68 may have a hex shaped outside surface to facilitate securing the cap assembly 28 to the injector body 22. An annular spacer 80 between a bottom surface 82 of the cap body 30 and an upper end 84 of the outer end coupling 26 determines an axial position of the cap assembly 28 relative to the injector body 22, which also determines an air gap 86 between an upper face of the armature flange 50 and a lower end face of the solenoid pole 34. As shown in FIG. 4, the upper end 84 of the outer end coupling includes an annular bead 88 that concentrates force within the connection between the bottom surface 82 of the cap body 30 and the upper end 84 of the outer end coupling 26. The concentrated force enhances sealing between the outer end coupling 26 of the injector body 22 and the cap body 30 to contain low-pressure fuel within the fuel injector 10 and produce a predictable axial position of the cap assembly 28 relative to the injector body 22 when the cap collar 68 is tightened to a specified torque. The annular spacer 80 is a simple form similar to a washer, where the material and dimensions of the annular spacer 80 may be selected to produce a desired seal and position of the cap assembly 28 relative to the injector body 22.

The armature spring 44 biases the armature 48 and control valve member 54 toward a closed position as shown in FIG. 4. With reference to FIG. 3, the armature stroke 90 (and axial movement of the control valve member 54) is controlled by the spring seat 46, which contacts an armature stop 39 at the bottom end face of the armature spring cage 40 as the armature 48 is attracted toward the solenoid pole 34. The spring seat 46 defines the axial travel or stroke 90 of the armature 48 and control valve member 54 by limiting axial movement of the armature 48 toward the pole 34 of the solenoid. A central portion of the spring seat 46 supports an annular shim 92 in contact with a lower end of the armature spring 44. The axial height of the shim 92 sets the force applied to the armature 48 by the armature spring 44. According to aspects of the disclosure, the armature air gap 86, stroke 90 and spring force are set by selection of the annular spacer 80, spring seat 46 and shim 92, each of which have a simple shape that can be inexpensively produced with close tolerance. The annular spacer 80, spring seat 46 and shim 92 can be accessed by unscrewing the cap collar 68 from the injector body 22. Adjustments to the air gap, 86 armature stroke 90, and armature spring force can be accomplished without changes to the other components of the fuel injector 10. The air gap 86 is typically selected to be greater than the armature stroke 90, so the armature 48 does not strike the solenoid pole 34 during operation of the control valve 15.

The fuel inlet coupling 20 delivers high-pressure fuel to high-pressure flow paths defined in the injector body. A first high-pressure flow path 100 extends laterally and supplies high-pressure fuel to a chamber 102 surrounding the control module 60, while a second high-pressure flow path 104 extends axially and delivers high-pressure fuel to the nozzle end 12 of the fuel injector 10. The control module 60 includes a stepped axial bore 106 defining a needle control chamber 108 that receives an upper end of a control rod 110. The stepped axial bore 106 extends from the needle control chamber 108 to a control valve seat 112 on an upper end face 114 of the control module 60. An opening of the stepped axial bore 106 at the control valve seat 112 defines a flow restriction 113 limiting the rate at which high-pressure fuel is released from the needle control chamber 108. The control module 60 also defines a transverse bore including a flow restriction 116 that limits the rate at which high-pressure fuel can enter the needle control chamber 108 from the surrounding chamber 102. The flow restriction 113 at the control valve seat 112 determines the rate at which fuel pressure drops in the needle control chamber 108 after opening of the control valve member 54, which is directly related to the opening velocity of the injector needle 118. The flow restriction 116 between the annular chamber 102 and the needle control chamber 108 determines the rate at which high-pressure fuel fills the needle control chamber 108 after closure of the control valve member 54, which is directly related to the closing velocity of the injector needle 118.

A lower end 120 of the control module 60 is tapered and received in an axial bore 122 in the injector body 22 to center the control module 60 within the injector body 22. The axial position of the control module 60 is determined by an outward projecting shoulder 124 of the control module 60 resting on an inward projecting shoulder 126 within the axial bore 122 of the injector body 22. The control module 60 is clamped in place by a lower end face 115 of the clamping screw 58 against the upper end face 114 of the control module 60. In the disclosed fuel injector 10, the control module 60 is constructed of hard material such as tool steel, while the injector body 22 is constructed of softer material such as 4140 stainless steel. Axial force applied to the control module 60 by the clamping screw 58 produces a seal between the lower end face 115 of the clamping screw 58 and the upper end face 114 of the control module 60 and between the shoulder 124 control module 60 and the annular shoulder 126 of the injector body 22. In the disclosed fuel injector 10, an annular seal 128 surrounds the lower end 120 of the control module 60 to isolate high-pressure fuel in the annular chamber 102 surrounding the control module 60 from the region surrounding the control rod 110, which is at low-pressure.

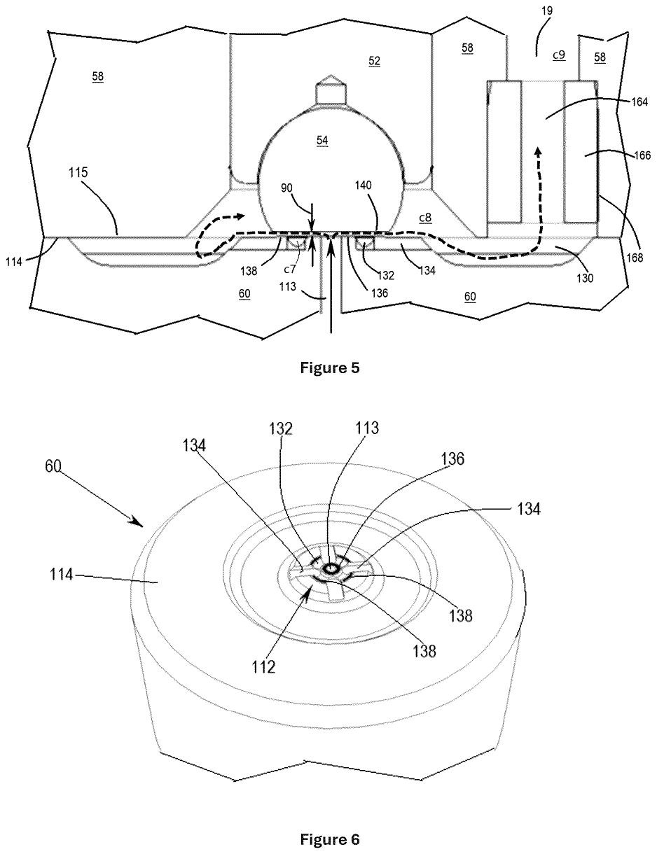

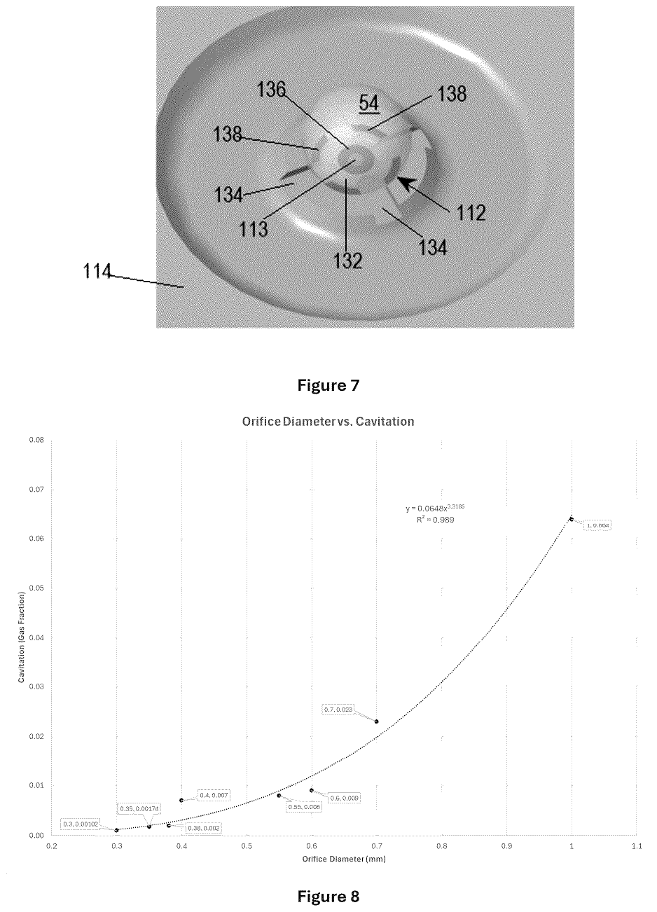

As shown in FIGS. 4 and 5, the lower end face 115 of the clamping screw 58 and the upper end face 114 of the control module 60 together define a control valve exit cavity 130. The control valve exit cavity 130 surrounds the valve seat 112 on the upper end face 114 of the control module 60. FIGS. 6 and 7 show details of the control valve seat 112 according to aspects of the disclosure. The surface area contact between the control valve member 54 and the control valve seat 112 are reduced by a toroidal cut 132 and radial grooves 134. The control valve seat 112 includes a planar annular central region 136 and coplanar outer regions 138 radially spaced from the annular central region 136 separated from each other by the radial grooves 134. The annular central region 136 and outer regions 138 are planar and in the same plane, or coplanar with each other. The number of radial grooves 134 shown is four, but other numbers of radial grooves may be used. The outer regions 138 contact and support the periphery of the control valve member 54 when the control valve member 54 is in the closed position. Interrupting the control valve seat 112 with the toroidal cut 132 and radial grooves 134 reduces fluid stiction between an end face 140 of the control valve member 54 and the control valve seat 112, allowing the control valve member 54 to open and close quickly. According to another aspect of the disclosure, a recess surrounding the planar annular central portion 136 of the control valve seat 112 results in a first region of fuel pressure immediately adjacent the outlet 113 of the needle control chamber 108.

According to aspects of the disclosure, the control valve member 54 is a flattened ball secured to the end of the valve stem 52. The ball is first attached to the valve stem 52 and then ground to form a planar end face 140 facing the valve seat 112, where the planar end face 140 is perpendicular to the direction of movement of the control valve member 54. Configuring the control valve seat 112 and control valve member 54 with planar mating surfaces reduces the need for precision with respect to concentricity of the control valve member 54 relative to the control valve seat 112. Reducing the need for precise concentricity of the control valve member 54 and control valve seat 112 reduces manufacturing cost of the disclosed fuel injector 10. According to another aspect of the disclosure, the planar control valve surface 140 cooperates with features of the control valve seat 112 to manage flow of high-pressure fuel into the control valve exit chamber 130 when the control valve 15 is open.

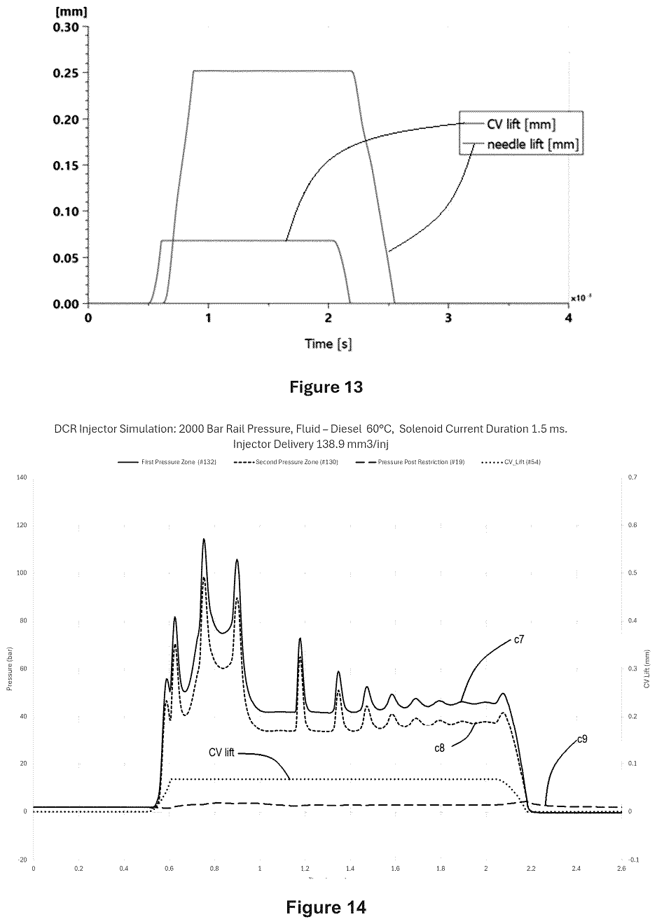

FIG. 13 graphically presents the position of the control valve member 54 (CV) and injector needle 118 when the control valve 15 is opened for approximately 1.5 ms. The control valve member 54 is opened by a stroke 90 (CV lift) of approximately 0.07 mm, which produces a corresponding opening of the injector needle of approximately 0.25 mm (needle lift). The stroke 90 of the armature 48 and the control valve member 54 is small, between 0.05 mm and 0.10 mm according to aspects of the disclosure. As shown in FIG. 5, the limited space between the control valve surface 140 and the control valve seat 112 allows the configuration of the control valve seat 112 to influence flow of the high-pressure fuel and produce a gradual drop in fuel pressure between the outlet 113 of the needle control chamber 108 and the control valve exit chamber 130. FIG. 14 graphically presents pressure c7 at the recess 132 surrounding the outlet 113 of the needle control chamber 108, pressure c8 in the control valve exit chamber 130 and pressure c9 corresponding to pressure in the low-pressure fuel return flow path 19 after the control valve exit chamber outlet flow restriction 164. The configuration of the control valve seat 112 produces a first zone of fuel pressure c7 immediately adjacent the outlet 113 in the recess 132 and a second zone of fuel pressure c8 in the control valve exit chamber 130. Fuel pressure in the low-pressure fuel return flow path 19 after the flow restriction 164 remains near zero, while the fuel pressure in pressure zones c7 and c8 remain elevated for the entire period the control valve 15 is open, keeping the fuel pressure in the control valve exit chamber 130 safely above the vapor pressure of the fuel.

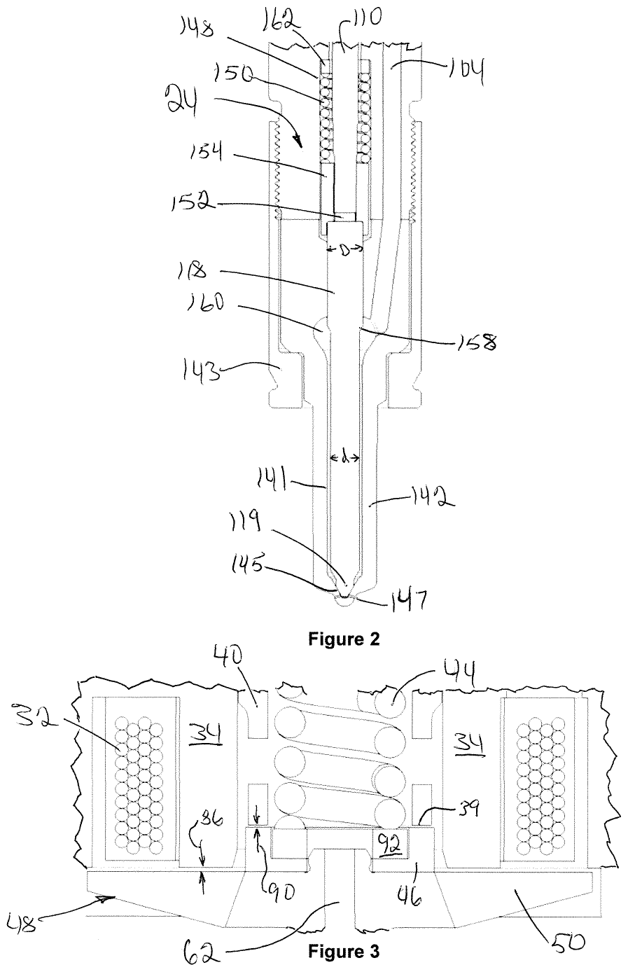

The control rod 110 extends from the needle control chamber 108 to the nozzle end 12 of the injector body 22 adjacent the injector nozzle 142. The injector nozzle 142 is connected to the threaded nozzle end coupling 24 by a nozzle collar 143 and defines an axial bore 141 within which the injector needle 118 reciprocates between closed and open positions. The nozzle collar 143 has an inward projecting shoulder that engages an outward shoulder on the injector nozzle to compress an upper face of the injector nozzle against a lower end face of the nozzle end coupling 24 to form a fluid-tight seal. When the control valve 15 is in the closed position, high-pressure fuel fills the needle control chamber 108 and generates a defined force on the control rod 110 toward the nozzle end 12 of the fuel injector 10. A stepped bore 144 in the injector body 22 includes an annular guide 146 to center the control rod 110 and guide its movement. The control rod 110 extends into a needle spring chamber 148 and needle spring 150 arranged to bias the injector needle 118 toward a closed position where a needle tip 119 is seated against a needle seat 145 to prevent high pressure fuel from being sprayed through a plurality of fuel injection orifices 147 defined in the injector nozzle 142 downstream of the needle seat 145. As shown in FIG. 2, an upper end of the injector needle 118 extends into the needle spring chamber 148 and a needle lift spacer 152 is positioned between the upper end of the injector needle 118 and a lower end of the control rod 110. An alignment coupling 154 aligns the lower end of the control rod 110, the needle lift spacer 152 and the upper end of the injector needle 118, so that force from the control rod 110 is applied to the injector needle 118 via the needle lift spacer 152. The alignment coupling 154 is configured to direct force of the needle spring 150 to the injector needle 118 separately from the force applied to the injector needle 118 by the control rod 110. The needle spring force is typically selected to balance the opening force of high-pressure fuel surrounding the injector needle 118 so that removal of force from the control rod 110 results in opening of the injector needle 118. It is typical for the opening force of high-pressure fuel on the injector needle 118 to be greater than the closing force of the needle spring 150, which results in the injector needle 118 remaining in contact with the control rod 110 as the control rod 110 moves away from the injector needle 118 after opening of the control valve 15. The axial thickness of the needle lift spacer 152 determines the maximum axial lift of the injector needle 118 by defining the axial position of the control rod 110 within the needle control chamber 108. Axial movement of the control rod 110 and injector needle 118 are limited by contact between an upper end of the control rod 110 and an annular control rod stop 156 at the top of the needle control chamber 108. It will be apparent to those skilled in the art that the injector needle 118 may not reach its maximum axial lift for fuel injection pulses of short duration.

As is known in the art, an upper end of the injector needle 118 has a larger diameter D than a diameter d of a lower end of the injector needle, with an annular shoulder 158 defining a transition between the two diameters. The annular shoulder 158 is positioned in a chamber 160 in the nozzle 142 surrounding the injector needle 118 and filled with high-pressure fuel. The high-pressure fuel exerts an upward (opening) force on the injector needle 118, which is countered by the force of the needle spring 150 and control rod 110 to maintain the injector needle 118 in a closed position when the control valve 15 is closed and high-pressure fuel in the needle control chamber 108 exerts a downward force on the control rod 110. Force exerted by the needle spring 150 can be adjusted by selecting the thickness of a needle spring shim 162 shown at the top of the needle spring chamber 148 in FIG. 2. The force of the needle spring 150 is selected so that the injector needle 118 will open promptly when the force on the control rod 110 is removed by opening the control valve 15.

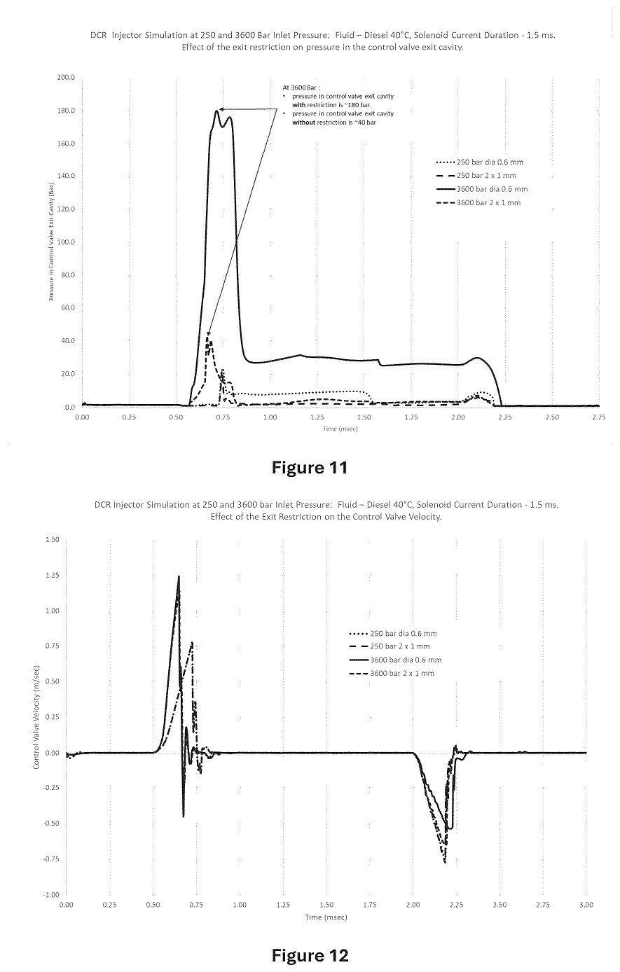

In the disclosed fuel injector 10, cavitation is likely to occur at the control valve seat 112 as high-pressure fuel is released from the needle control chamber 108 through flow restriction 113 when the control valve 15 is opened. Opening the control valve 15 exposes high-pressure in the needle control chamber to low-pressure in the fuel return flow path 19. As shown in FIGS. 4 and 5, the disclosed fuel injector 10 defines a control valve exit chamber 130 between the lower end face 115 of the clamping screw 58 and the upper end face 114 of the control module 60. According to aspects of the disclosure, the control valve exit chamber 130 is configured to manage the pressure drop of fuel as it passes through the flow restriction 113 in the control valve seat 112. The control valve exit chamber 130 is configured to have a volume sufficient to reduce pressure in the needle control chamber 108 when the control valve 15 is opened, where the pressure drop in the needle control chamber 108 occurs rapidly and is sufficient to produce movement of the control rod 110 and injector needle 118. According to aspects of the disclosure, a flow restriction 164 between the control valve exit chamber 130 and the low-pressure fuel return flow path 19 maintains fuel pressure within the control valve exit chamber 130 after opening of the control valve 15 above the vapor pressure of the fuel to prevent cavitation at the control valve seat 112. The flow restriction 164 in combination with the limited volume of the control valve exit chamber 130 produce a rapid increase in fuel pressure in the control valve exit chamber 130 when the control valve 15 is opened. With reference to FIG. 11, computer simulations of fuel injector operation at a fuel pressure of 3600 bar and a fuel temperature of 40° C. show that fuel pressure in the control valve exit chamber 130 remains safely above the vapor pressure of the (diesel) fuel while the control valve 15 is open.

According to aspects of the disclosure, one structure useful for defining the flow restriction 164 is a hollow cylindrical insert 166 in a stepped bore 168 defining the flow path for fuel from the control valve exit chamber 130 to the low-pressure fuel return flow path 19. The flow restriction 164 may also be defined by a drilled orifice in the clamping screw 58 communicating with the stepped bore 168. The inside diameter of the cylindrical insert 166 defines the flow restriction 164, which is selected to restrict flow of fuel from the control valve exit chamber 130 so that pressure within the control valve exit chamber 130 quickly rises and remains above the vapor pressure of the fuel while the control valve 15 is open. Using a cylindrical insert 166 to define the flow restriction 164 allows the flow restriction 164 to be adjusted by selection of a different cylindrical insert 166, while the same clamping screw 158 can be used. The volume of the control valve exit chamber 130 and the diameter of the flow restriction 164 are selected so that the fuel pressure in the control valve exit chamber 130 is maintained above the vapor pressure of the fuel over the expected range of operating temperatures and conditions of the fuel system.

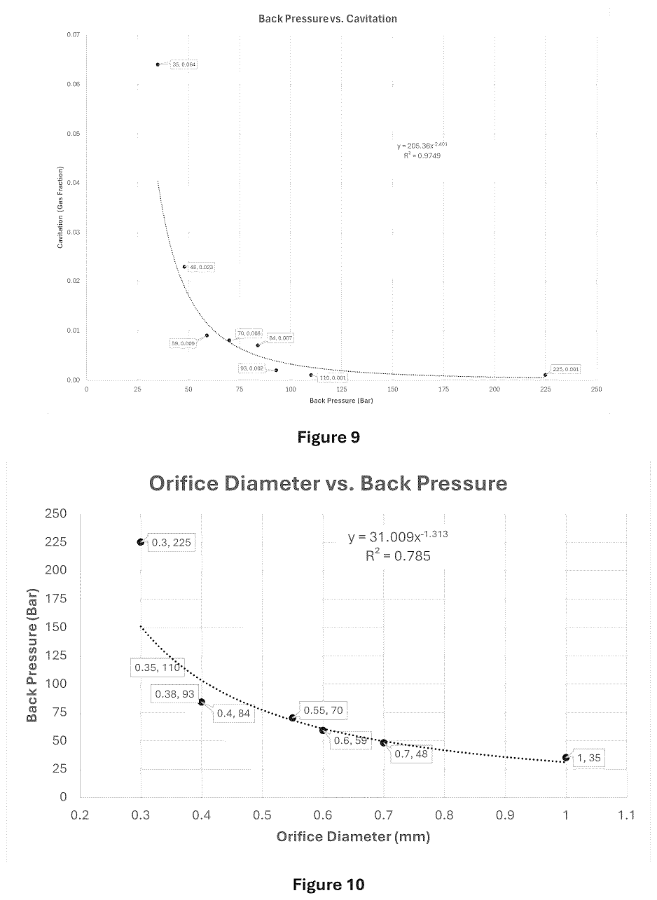

FIGS. 8-10 graphically illustrate the effect of changes in the diameter (flow capacity) of the flow restriction 164 on cavitation (FIGS. 8 and 9) and back pressure in the control valve exit chamber 130 (FIG. 10). FIGS. 11 and 12 are graphical presentations of simulations comparing the effect of changes in the diameter (flow capacity) of the flow restriction 164 on back pressure in the control valve exit chamber 130 (FIG. 11) and opening and closing velocity of the control valve member 154 (FIG. 12). Simulations were carried out using the disclosed fuel injector configuration at 250 bar and 3600 bar, Diesel fuel at 40° C. and application of electrical current to the solenoid coil for a duration of 1.5 ms. Simulations were conducted to compare the effect of a flow restriction 164 with a diameter of 0.6 mm to two orifices each having a diameter of 1 mm representing very low or no flow restriction from the control valve exit chamber 130. These simulations compare a relatively unrestricted flow between the control valve exit chamber (2×1 mm diameter orifices) with a flow restriction identified as effectively maintaining fuel pressure in the control valve exit chamber (one 0.6 mm diameter orifice). As shown in FIG. 11, fuel pressure in the control valve exit chamber 130 is significantly greater over the duration of the control valve 15 open condition by a single orifice of 0.6 mm diameter compared with two 1 mm diameter openings. As shown in FIG. 12, the opening and closing velocity of the control valve member 154 is not changed by restricting flow between the control valve exit chamber 130 and the low-pressure fuel return flow path 19. These results show that the combination of a control valve exit chamber 130 with a volume of approximately 10 mm³ and a flow restriction 164 with a diameter of 0.6 mm produce fuel pressure above the vapor pressure of diesel fuel while the control valve 15 is open.

The operating characteristics of a fuel injector are directly related to performance and emissions of the internal combustion engine. This places a premium on the consistency and reliability of the fuel injectors. The disclosed fuel injectors facilitate tuning of the fuel injector 10 for different fuel systems and internal combustion engine configurations by selection of a limited number of simple components accessible during assembly of the fuel injector 10. The disclosed fuel injector 10 can be reconfigured by replacement of one or more of these simple components.

What is claimed:

1. A fuel injector for delivering fuel to an internal combustion engine, the fuel injector comprising:
an injector needle having a closed position closing injection orifices in an injector nozzle and an open position allowing pressurized fuel to flow through the injection orifices in the injector nozzle, movement of the injector needle from the closed position to the open position is determined by fuel pressure in a needle control chamber, with the injector needle urged toward the closed position when the needle control chamber is filled with pressurized fuel and relieving pressure in the needle control chamber causes the injector needle to move to the open position;
a control valve controlling flow of pressurized fuel from the needle control chamber, said control valve comprising:
a control valve seat including a planar central region surrounding a control valve chamber outlet and a recess surrounding the planar region;
a control valve exit chamber in fluid communication with the control valve seat, said control valve exit chamber including a control valve exit chamber flow restriction between the control valve exit chamber and a region of low fuel pressure;
a control valve member having a planar control valve surface biased into a closed position against the control valve seat; and
a solenoid configured to move the control valve member against the bias to an open position where the valve surface is spaced apart from the control valve seat,
wherein when the control valve member is moved to the open position, pressurized fuel leaves the control valve chamber through the control valve chamber outlet, passes between the control valve surface and the planar central region to pressurize the recess to a first fuel pressure and pressurize the control valve exit chamber to a second fuel pressure before passing through the control valve exit chamber flow restriction, said first fuel pressure being greater than said second fuel pressure.

2. The fuel injector of claim 1, wherein said control valve seat includes at least one radial cut extending between the recess and the control valve exit chamber.

3. The fuel injector of claim 1, wherein the control valve seat includes at least one planar outer region radially spaced from the planar central region, said planar control valve surface extending across the recess to contact the at least one planar outer region when the control valve is in the closed position.

4. The fuel injector of claim 1, wherein the planar central region is annular and the recess is annular and surrounds the annular central region.

5. The fuel injector of claim 4, wherein the annular recess is a half-torus or a circular trough.

6. The fuel injector of claim 1, wherein the control valve seat includes a plurality of radial cuts extending between the recess and the control valve exit chamber and a plurality of planar outer regions radially spaced from the planar central region by the recess, said plurality of planar outer regions co-planar with the planar central region, said planar control valve surface extending across said recess to contact the plurality of planar outer regions when the control valve is in the closed position.

7. The fuel injector of claim 1, wherein the first and second fuel pressures are above a vapor pressure of the fuel.

8. A fuel injector comprising:
an injector body defining a central bore extending from a low-pressure fuel return outlet to a nozzle end, said low-pressure fuel return outlet connected to a low-pressure fuel return flow path;
a high-pressure fuel inlet communicating with the central bore at a position intermediate the low-pressure fuel return outlet and the nozzle end;
a control module seated in said central bore, said control module defining a needle control chamber in fluid communication with the high-pressure fuel inlet via a restricted inlet opening, said needle control chamber facing the nozzle end of the injector body, said control module defining a restricted outlet between the needle control chamber and a valve seat on an upper end face of the control module, said valve seat facing the low-pressure fuel outlet, said valve seat comprising a planar central region surrounding the restricted outlet and an a recess surrounding the planar central region;
a valve member biased toward the valve seat, said valve member having a planar valve surface which closes the restricted outlet when the valve surface is in contact with the valve seat;
a control valve exit chamber partially defined by the upper end face of the control module, said control valve exit chamber surrounding the valve seat and including a control valve exit chamber flow restriction between the control valve exit chamber and the low-pressure fuel return flow path;
a solenoid connected to move the valve member from a closed position where the valve surface closes the restricted outlet, to an open position where the valve surface is separated from the valve seat by a valve surface axial lift;
a control rod extends from an upper end in said needle control chamber to a lower end bearing on an injector needle,
wherein when the valve member is in the closed position, the needle control chamber is filled with high-pressure fuel which generates a needle closing force on the control rod toward the injector needle and when the valve member is moved to the open position by the solenoid, high-pressure fuel is released from the needle control chamber through the restricted outlet and the needle closing force is relieved, high-pressure fuel leaves the needle control chamber between the valve surface and the planar central region of the valve seat, through the recess and into the control valve exit chamber, pressurizing first the recess and then the control valve exit chamber before flowing through the control valve exit chamber flow restriction to the low-pressure fuel return outlet.

9. The fuel injector of claim 8, wherein said control valve seat includes at least one radial cut extending between the recess and the control valve exit chamber.

10. The fuel injector of claim 8, wherein the control valve seat includes at least one planar outer region radially spaced from the planar central region, said planar control valve surface extending across the recess to contact the at least one planar outer region when the control valve member is in the closed position.

11. The fuel injector of claim 8, wherein the planar central region is annular and the recess is annular and surrounds the annular central region.

12. The fuel injector of claim 11, wherein the annular recess is a half-torus or a circular trough.

13. The fuel injector of claim 1, wherein the control valve seat includes a plurality of radial cuts extending between the recess and the control valve exit chamber and a plurality of planar outer regions radially spaced from the planar central region by the recess, said plurality of planar outer regions co-planar with the planar central region, said planar control valve surface extending across said recess to contact the plurality of planar outer regions when the control valve member is in the closed position.

14. A fuel injector comprising:
an injector body extending from an outer end including an outer end coupling to a nozzle end including a nozzle end coupling, said injector body defining a central bore extending from the outer end coupling to the nozzle end coupling, said injector body including a high-pressure fuel inlet communicating with said central bore between the outer end coupling and the nozzle end coupling, said central bore including a needle spring chamber adjacent the nozzle end coupling;
a cap assembly connected to the outer end coupling, said cap assembly comprising:
a fuel return outlet defining a low-pressure fuel return flow path connected to a low-pressure fuel return flow path and an axial bore facing the outer end coupling;
an annular cap body having a fluid-tight connection to the low-pressure fuel return outlet;
a solenoid pole radially surrounded by the cap body, said cap body defining a central opening aligned with the axial bore in the fuel return outlet, the solenoid pole further defining an annular cavity;
a coil seated in the annular cavity of the solenoid pole;
an electrical connector including electrical connections and conductors to supply electrical energy to the coil;
an annular cap spacer between a bottom surface of the cap body and an upper surface of the outer end coupling, said annular cap spacer setting an axial position of the cap assembly relative to the injector body; and
a cap collar radially surrounding the cap body, said cap collar configured to reversibly couple the cap assembly to the outer end coupling of the injector body;
a cylindrical armature spring cage seated in the central opening of the solenoid pole and extending into the aligned axial bore of the fuel return outlet, said armature spring cage defining an armature spring bore, and extending from an upper end seated against a spring cage stop defined at an upper end of the axial bore of the fuel return outlet to a lower end including an annular armature stop facing away from the low-pressure fuel return outlet;
an armature spring in the armature spring bore;
an armature including a radial flange facing the solenoid pole and an integral axially extending valve stem with a control valve member connected to an end of the valve stem opposite the radial flange, said control valve member having a planar control valve surface facing away from the radial flange;, said armature having an upper surface supporting a spring seat with a peripheral rim facing the armature stop of the armature spring cage, an axial thickness of the spring seat rim defining a gap with the armature stop corresponding to the axial travel of the armature and control valve member between a closed and open position, a central portion of the spring seat supporting a an armature spring shim in contact with the armature spring, an axial thickness of the armature spring shim selected to set a predetermined armature spring force to bias the armature away from the solenoid pole and into a closed position;
a clamping screw defining an axial bore and having a threaded outer surface engaged with the outer end coupling, the valve stem received in the axial bore of the clamping screw for reciprocal, axial movement therein, said clamping screw having a lower end face partially defining a control valve exit chamber and including a control valve exit chamber flow restriction in fluid communication with the low-pressure fuel return path;
a control module a control module seated in said central bore, said control module defining a needle control chamber in fluid communication with the high-pressure fuel inlet via a restricted inlet opening, said needle control chamber facing the nozzle end of the injector body, said control module defining a restricted outlet between the needle control chamber and a valve seat on an upper end face of the control module, said valve seat facing the lower end face of the clamping screw, said valve seat comprising a planar central region surrounding the restricted outlet and a recess surrounding the annular central region, the upper end face of the control module cooperating with the lower end face of the clamping screw to define the control valve exit chamber, an annular periphery of the lower end face of said clamping screw contacting the upper end face of the control module to define a radial limit of the control valve exit chamber and clamp the control module in a fixed position within the central bore of the injector body;
a control rod extends in the central bore of the injector body from an upper end in the needle control chamber to a lower end adjacent the nozzle end of the injector body;
an injector nozzle including an elongated bore extending from an upper end of the injector nozzle adjacent the nozzle coupling of the injector body to a needle seat, said injector nozzle defining a plurality of fuel injection orifices downstream of the needle seat, the elongated bore including a needle chamber in communication with the high-pressure fuel inlet via a passage in the injector body;
an injector needle in the elongated bore of the injector nozzle, said injector needle extending from an upper end in contact with a needle lift spacer and an alignment coupling to a needle tip configured to mate with the needle seat when the injector needle is in a closed position to prevent high-pressure fuel from passing through the fuel injection orifices;
a needle spring and needle spring shim are arranged in the needle spring chamber with the needle spring biased between the needle spring shim and the alignment coupling to bias the injector needle toward the closed position, a closing force of the needle spring is adjusted by selecting the axial thickness of the needle shim and/or an axial height of the alignment coupling between an upper end of the injector needle and a lower end of the needle spring; and
a nozzle collar surrounding a joint between the nozzle end of the injector body and the upper end of the injector nozzle, said nozzle collar configured to reversibly couple the injector nozzle to the nozzle end coupling of the injector body,
wherein application of electrical current to the coil generates a magnetic field which attracts the armature toward the solenoid pole and moves the control valve surface away from the control valve seat, allowing pressurized fuel in the needle control chamber to pass through the restricted outlet into the control valve exit chamber, reducing fuel pressure in the needle control chamber, allowing the injector needle to move to an open position where high-pressure fuel passes the needle seat and is sprayed from the fuel injection orifices.

15. The fuel injector of claim 14, wherein the cap collar and outer end coupling are in threaded engagement and removal of the cap collar allows replacement of the annular cap shim, armature spring seat and armature shim.

16. The fuel injector of claim 14, wherein the nozzle collar and nozzle end coupling are in threaded engagement and removal of the nozzle collar allows replacement of the needle lift spacer, needle spring shim, and alignment coupling.

17. The fuel injector of claim 14, wherein an air gap between the armature flange and the solenoid pole, the armature spring force, and the armature stroke can be adjusted by reversing the reversible connection between the cap collar and the outer end coupling and selection of the cap shim, armature shim and armature spring seat, respectively.

18. The fuel injector of claim 14, wherein the maximum lift of the injector needle, and the spring force of the needle spring can be adjusted by reversing the reversible connection between the nozzle collar and the nozzle end coupling and selection of the needle lift spacer, needle spring shim and/or alignment coupling, respectively.

19. The fuel injector of claim 14, comprising an annular pressure seal surrounding the control module to isolate a region of high fuel pressure communicating with the high-pressure fuel inlet from the central bore of the injector body between the control module and the needle spring chamber.
